(19) United States
(12) Patent Application Publication
(10) Pub. No.: US 2026/0272044 A1
(43) Pub. Date: Sep. 17, 2026

(54) STATISTICAL APPLICATION OF RFID TECHNOLOGY IN AUTHENTICATING A CAPSULE

(71) Applicant: Altria Client Services LLC, Richmond, VA (US)

(72) Inventors: Eric HAWES, Midlothian, VA (US); Zack W. BLACKMON, Williamsburg, VA (US); Rangaraj S. SUNDAR, Midlothian, VA (US); Jarrett KEEN, Richmond, VA (US); Raymond W. LAU, Glen Allen, VA (US); Niall GALLAGHER, Cambridge (GB)

(73) Assignee: Altria Client Services LLC, Richmond, VA (US)

(21) Appl. No.: 19/564,673

(22) Filed: Mar. 12, 2026

Related U.S. Application Data
(60) Provisional application No. 63/771,236, filed on Mar. 13, 2025.

(51) Int. Cl. A24F 40/53; A24F 40/57; A24F 40/60; A24F 40/65; B65D 77/28

(52) U.S. Cl. CPC A24F 40/53; A24F 40/57; A24F 40/60; A24F 40/65; B65D 77/28

(57) ABSTRACT

Various example embodiments relate to an aerosol generating device, system, method, and/or non-transitory computer readable medium for authenticating capsules compatible with the aerosol generating device using statistical analysis of security tags. The aerosol generating device may include a housing configured to receive a capsule, the capsule containing an aerosol-forming substrate; a heating element configured to heat the aerosol-forming substrate to generate an aerosol; and control circuitry configured to, determine whether the capsule includes a security tag using a security sensor, increment a counter based on results of the determining whether the capsule includes the security tag, and determine a statistical probability of authenticity of the capsule based on a count of the counter and a first desired threshold value.

### CROSS-REFERENCE TO RELATED APPLICATIONS

This U.S. non-provisional application claims the benefit of priority from U.S. Provisional Application No. 63/771,236, filed Mar. 13, 2025, in the USPTO, the entire disclosure of which is incorporated by reference herein.

### BACKGROUND

### Field

Various example embodiments relate to systems, apparatuses, methods, and/or non-transitory computer readable media related to statistical applications of radio frequency identification (RFID) technology in authenticating a capsule, particularly in authenticating capsules compatible with an aerosol generating device, such as a heat-not-burn (HNB) device, etc.

### Description of Related Art

Some electronic devices are configured to heat a plant material to a temperature that is sufficient to release constituents of the plant material while keeping the temperature below a combustion point of the plant material so as to avoid any substantial pyrolysis of the plant material. Such devices may be referred to as aerosol generating devices (e.g., heat-not-burn (HNB) aerosol generating devices, e-vapor aerosol generating devices, not-heated inhalable devices, etc.), and the plant material heated may be tobacco. In some instances, the plant material may be introduced directly into a heating chamber of an aerosol generating device. In other instances, the plant material may be pre-packaged in individual capsules (e.g., pods, consumables, cartridges, containers, etc.) to facilitate insertion and removal from an aerosol generating device.

However, individuals or businesses may attempt to sell or distribute inauthentic capsules, e.g., counterfeit capsules, inauthentic capsules, capsules that have been tampered with, etc. The plant material that is included in these inauthentic capsules may contain an illegal and/or undesired substance, additives, chemicals, and/or other materials which may be of lower quality than the plant material included in authentic capsules, and/or may have a less desirable flavor than authentic plant material, etc. Additionally, the inauthentic capsules themselves may be of lower manufacturing quality and/or may be tampered with and therefore may pose an increased risk for operational errors by, for example, causing the operating temperature of an associated heating element to operate at undesirable levels, etc. Moreover, the inauthentic capsules may be tampered with in an attempt to defeat security features (e.g., age verification features, identity verification features, geographical location restrictions, medicinal prescription restrictions, etc.) provided by and/or reliant upon genuine capsules being inserted into the aerosol generating device.

Accordingly, there is a desire for accurate, reliable, and cost effective methods of authenticating capsules to ensure that the capsules are genuine.

### SUMMARY

Various example embodiments relate to systems, apparatuses, methods, and/or non-transitory computer readable media for authenticating a capsule of an aerosol generating device based on statistical analysis of at least one security tag of a plurality of capsules.

At least one example embodiment relates to an aerosol generating device. In an example embodiment, the aerosol generating device may include a housing configured to receive a capsule, the capsule containing an aerosol-forming substrate, a heating element configured to heat the aerosol-forming substrate to generate an aerosol, and control circuitry configured to, determine whether the received capsule includes at least one security tag using at least one security sensor, increment a counter based on results of the determining whether the received capsule includes the at least one security tag, and determine a statistical probability of authenticity of the received capsule based on a count of the counter and a first desired threshold value.

At least one example embodiment relates to a method of operating an aerosol generating device. In an example embodiment, the method may include determining, using control circuitry of the aerosol generating device, whether a capsule received by the aerosol generating device includes at least one security tag using at least one security sensor, the capsule containing an aerosol-forming substrate, incrementing a counter based on results of the determining whether the received capsule includes the at least one security tag, and determining a statistical probability of authenticity of the received capsule based on a count of the counter and a first desired threshold value.

At least one example embodiment relates to a retail package. In an example embodiment, the retail package may include a plurality of capsules each containing an aerosol-forming substrate, each capsule configured to be received by an aerosol generating device, and at least one capsule of the plurality of capsules included in the retail package includes at least one security tag, the at least one security tag configured to be detected by the aerosol generating device and enable the aerosol generating device to determine a statistical probability of authenticity of the received capsule.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a schematic view of an example heat-not-burn aerosol generating device according to at least one example embodiment;

FIG. 2 is an example electric circuit diagram of an aerosol generating device according to an example embodiment;

FIG. 3 is a flowchart illustrating an example method of statistically authenticating a capsule containing an aerosol generating substrate according to some example embodiments;

FIG. 4A is a flowchart illustrating an example method of distributing and packaging security tagged capsules to at least one capsule package according to some example embodiments;

FIG. 4B illustrates a first example method of distributing security tags according to FIG. 4A;

FIG. 4C illustrates a second example method of distributing of security tags according to FIG. 4A;

FIG. 4D illustrates a third example method of distributing of security tags according to FIG. 4A; and

FIG. 4E illustrates example probability curves associated with the third example method of FIG. 4D.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given example embodiment, and should not be interpreted as defining or limiting the range of values or properties encompassed by example embodiments.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Hardware may be implemented using processing or control circuitry such as, but not limited to, one or more processors, one or more Central Processing Units (CPUs), one or more microcontrollers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), one or more neural processing units (NPUs), or any other device or devices capable of responding to and executing instructions in a defined manner.

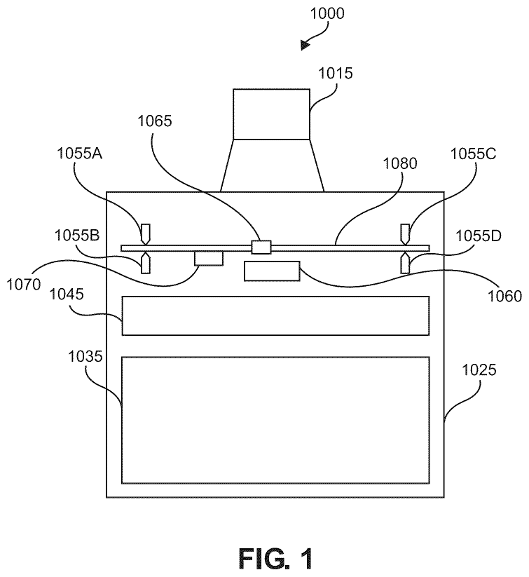

FIG. 1 is a schematic view of an example aerosol generating device according to at least one example embodiment.

While primary reference and illustration are made herein to the aerosol generating device 1000 being a heat-not-burn (HNB) aerosol-generating device, it is similarly contemplated that the aerosol generating device 1000 may additionally or alternatively be one or more other types of devices and/or inhalable devices for producing an inhalable substance from a consumable, such as, for example, an e-vapor device or a not-heated inhalable device. As used herein, a heat-not-burn device refers to a device configured to heat a consumable (e.g., an aerosol-forming substrate contained in a capsule) without igniting the consumable to yield the inhalable aerosol. As used herein, an e-vapor device refers to a device configured to vaporize a consumable (e.g., a pre-vapor formulation contained in a cartridge) to yield the inhalable aerosol (e.g., vapor). As used herein, a not-heated inhalable device refers to a device configured to disperse a material (e.g., a powder, a liquid, etc.) without using heat (e.g., via vibrations, pressurized release, etc.) to drive the generation of an inhalable dispersion of the material. For exemplary convenience, primary reference will now be made herein to the aerosol generating device 1000 as being a heat-not-burn aerosol generating device, but the example embodiments are not limited thereto, and for example, the aerosol generating device 1000 may be an e-vapor device, a not-heated inhalable device, etc.

Referring to FIG. 1, a heat-not-burn (HNB) aerosol generating device 1000 may include a mouthpiece 1015 and a device body 1025 (e.g., a housing of the aerosol generating device 1000, the body, the housing, etc.), but is not limited thereto. A power supply 1035 (e.g., a rechargeable battery, etc.) and control circuitry 1045 may be disposed within the device body 1025 of the heat-not-burn aerosol generating device 1000, but is not limited thereto. According to at least one example embodiment, the heat-not-burn aerosol generating device 1000 may include an I/O interface (not shown) and/or a network interface (not shown). The I/O interface may be a USB interface (e.g., a USB mini-cable interface, a USB-C cable interface, etc.), a power cable, etc. The network interface may be a Bluetooth transceiver (e.g., Bluetooth and/or Bluetooth Low Energy (LE), etc.), a Near Field Communication (NFC) transceiver, a radio-frequency identification (RFID) transceiver, a ZigBee transceiver, a Z-wave transceiver, a Matter/Thread transceiver, a WiFi transceiver, a cellular network transceiver (e.g., 4G LTE, 5G NR, 6G, etc.), etc., but the example embodiments are not limited thereto. Additionally, the HNB aerosol generating device 1000 may also include a puff sensor (not shown) for detecting a puff, for example, by detecting an application of negative air pressure on the mouthpiece 1015, etc. In response to the detection of the puff and/or application of negative air pressure by the puff sensor (e.g., automatic operation), the control circuitry 1045 may be configured to control the supply of electric current to one or more heating elements (e.g., heaters, etc.) of the heat-not-burn aerosol generating device 1000, etc. Alternatively, or additionally, the aerosol generating device 1000 may also include a power button and/or consumer engagement button, which when activated by the adult consumer (e.g., manual operation), causes the control circuitry 1045 to control the supply of electric current to the one or more heating elements (not shown) of the aerosol generating device 1000.

The heat-not-burn aerosol generating device 1000 is configured to receive a capsule 1080. The capsule 1080 is removable. According to at least some example embodiments, the capsule 1080 may include an aerosol-forming substrate (e.g., a pre-dispersion formulation, etc.) sandwiched in between one or more heating elements (e.g., heaters, resistive heating elements, inductive heating elements, etc.). According to at least some example embodiments, the aerosol generating device 1000 may include first and second resistive heating elements (not shown), and the heating elements may be planar and may be formed of a material that heats up when an electric current is applied thereto, but the example embodiments are not limited thereto. The heat-not-burn aerosol generating device 1000 may also include at least one electrode, such as a first electrode 1055a, a second electrode 1055b, a third electrode 1055c, and a fourth electrode 1055d etc., each configured to electrically contact the capsule 1080, but is not limited thereto. According to at least some example embodiments, the first electrode 1055a and the third electrode 1055c may electrically contact the first heating element, while the second electrode 1055b and the fourth electrode 1055d may electrically contact the second heating element. However, in non-limiting embodiments involving a capsule with only one heating element, it should be understood that the first electrode 1055a and the third electrode 1055c (or the second electrode 1055b and the fourth electrode 1055d) may be omitted. Additionally, according to other example embodiments, the heating element (and/or heater) may be disposed in the body of the aerosol generating device 1000 instead of the capsule 1080, the heating element of the aerosol generating device 1000 being in thermal contact with the aerosol generating substrate of the capsule 1080. Further, the aerosol generating device 1000 may include one or more inductive heating elements in addition to, or in place of, the resistive heating element(s). An inductive heating element may include one or more inductive heating coils and one or more conductors or susceptor (both magnetic or non-magnetic), the inductive heating coil formed of an electromagnetic material which causes the conductor or susceptor to heat up via eddy current losses (when non-magnetic material is used) or eddy current losses and hysteresis losses (when magnetic material is used) in response to an alternating electrical current being applied to the inductive heating coil, the conductor being in thermal contact with the aerosol generating substrate of the capsule 1080.

Additionally, according to some example embodiments, the aerosol generating device 1000 may further one or more security sensors 1060 for detecting, reading, and/or sensing at least one security tag 1065 installed, embedded, and/or attached to the capsule 1080. The security sensor 1060 (e.g., a security tag sensor, etc.) may be at least one of a RFID sensor, a NFC sensor, a secure element (SE) (e.g., a secure processing element, etc.), a barcode reader, an optical reader, and/or a physical parameter measurement sensor (e.g., heating element resistance measurement circuitry, etc.), or any combination thereof, but is not limited thereto. According to some example embodiments, the security tag 1065 may be a RFID tag, a NFC tag, a secure element (e.g., an EEPROM, etc.), a one-dimensional (1D) or two-dimensional (2D) barcode and/or quick response (QR) code, a desired physical parameter of the capsule 1080 (e.g., a desired resistance value of a heating element of the capsule, a desired temperature setting, a desired heating interval (e.g., an amount of time for operating the heating element, etc.), or any combinations thereof, but is not limited thereto. The security tag 1065 may store authentication information, such as a unique identifier supplied by a manufacturer including information indicating that the capsule is an authentic capsule such as a cryptographic security key (e.g., at least one of a public-private key, etc.), a serial number, a batch number, etc., but the example embodiments are not limited thereto. For example, the unique identifier may be a unique serialized number generated using a private encryption key stored by the manufacturer, but the example embodiments are not limited thereto. According to some example embodiments, a unique identifier (e.g., serialized number) is generated for each security tag included on a capsule in order to avoid the duplication (e.g., copying) and/or re-use of an authentic security tag and placement of the duplicate and/or re-used security tag on a counterfeit and/or tampered with capsule. Additionally, according to some example embodiments, the security tag 1065 may store parameters for setting and/or configuring the interval and/or time period for a next authentication check and/or future authentication check (e.g., an authentication check interval, etc.). For example, the manufacturer may store a new and/or updated capsule authentication check interval on the security tag 1065 which may re-program the aerosol generating device 1000 to perform the capsule authentication check at a different interval due to a change in the manufacturing and/or packaging process for the capsules, such as changing the ratio or packing scheme for tagging the capsules, changing the method of authentication, changing the encryption/decryption keys, etc. Moreover, the security tag 1065 may store parameters for communicating information about the consumables in this pack to the adult consumer, perhaps production data, quality information, plant material information, flavor information, etc. These parameters would be read by the aerosol generating device 1000 and communicated to the adult consumer via a display included in the aerosol generating device 1000 (e.g., an OLED screen, a TFT screen, a touchscreen, etc.), a speaker included in the aerosol generating device 1000, a companion software application (hereinafter referred to as a companion app) installed on a computing device (not shown) and/or electronic device (not shown) of the adult consumer, such as a smartphone, a tablet, a smartwatch, a laptop, a personal computer, etc., connected to the aerosol generating device 1000 by a wired and/or wireless connection, such as Bluetooth, NFC, WiFi, a cellular connection, a USB connection, etc.

According to some example embodiments, the security tag sensor 1060 will read, sense, and/or otherwise receive the authentication information stored in the security tag 1065 (and/or sense the authentication information corresponding to the security tag 1065) present on a capsule inserted and/or installed in the aerosol generating device 1000, and transmit the authentication information to the control circuitry 1045 of the aerosol generating device 1000. The control circuitry 1045 will then authenticate, verify, and/or otherwise evaluate the authentication information to determine whether the capsule is authentic or inauthentic (e.g., counterfeit, damaged, tampered with, manufactured by an unauthorized manufacturer, etc.). For example, the control circuitry 1045 may decrypt the authentication information using a public encryption key stored in the memory of the aerosol generating device 1000 corresponding to the private encryption key for generating the authentication information, but the example embodiments are not limited thereto.

As another example, if the security tag is information related to a desired physical parameter of the capsule 1080, the security tag 1065 may be authenticated based on a sensed and/or determined physical parameter of the capsule 1080 matching the desired physical parameter value stored in the security tag. For example, if the desired physical parameter is an expected resistance value of the heating element of the capsule 1080, then the control circuitry 1045 of the aerosol generating device 1000 will read the expected resistance heating element value using the security tag sensor 1060, sense and/or determine the actual heating element resistance value of the capsule 1080, and determine whether the expected heating element resistance value matches the actual heating element resistance value, etc., but the example embodiments are not limited thereto.

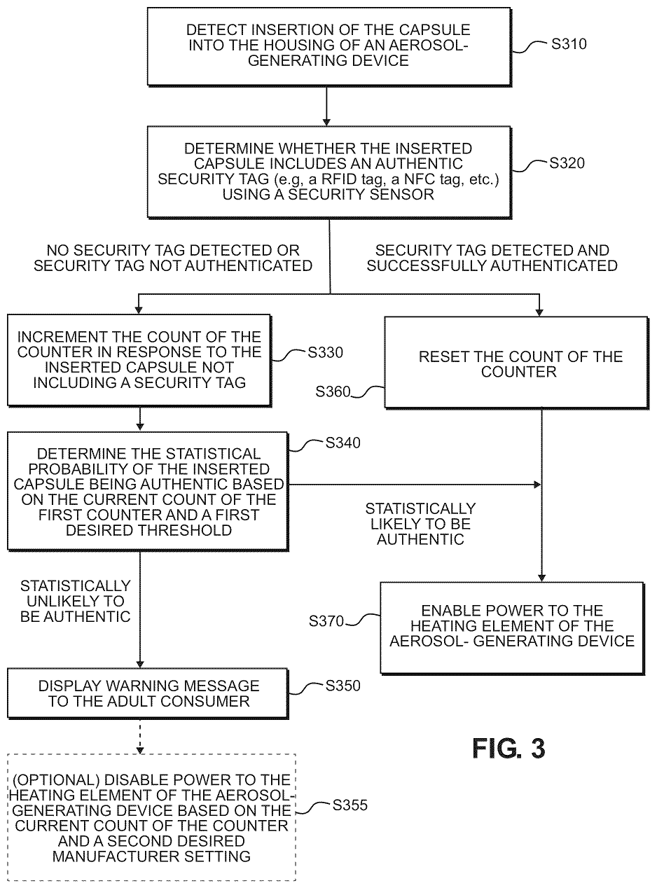

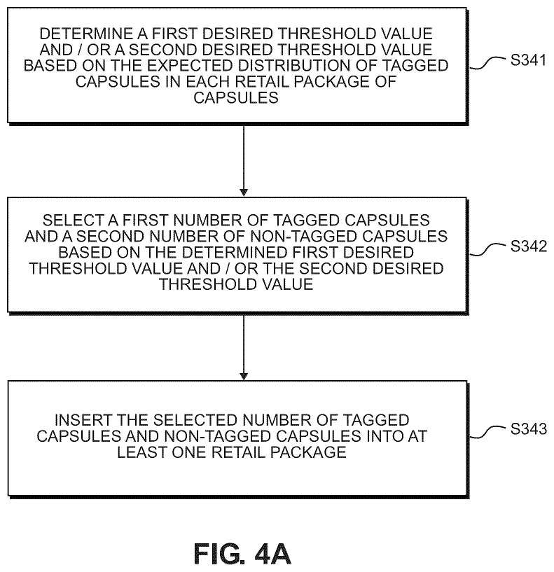

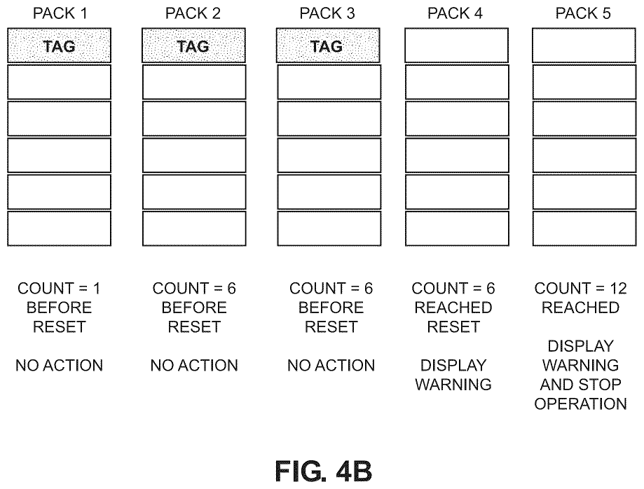

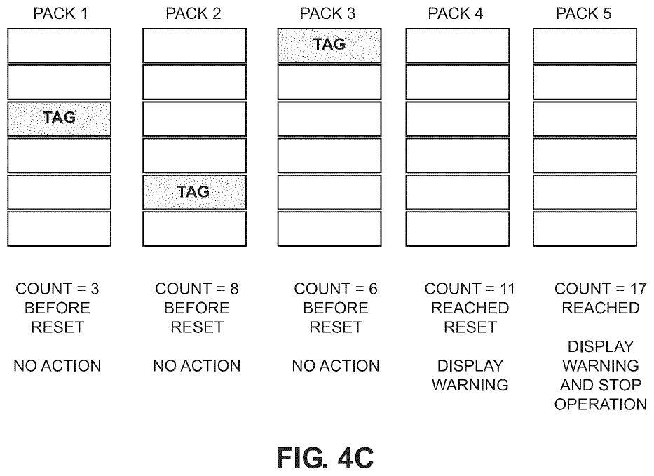

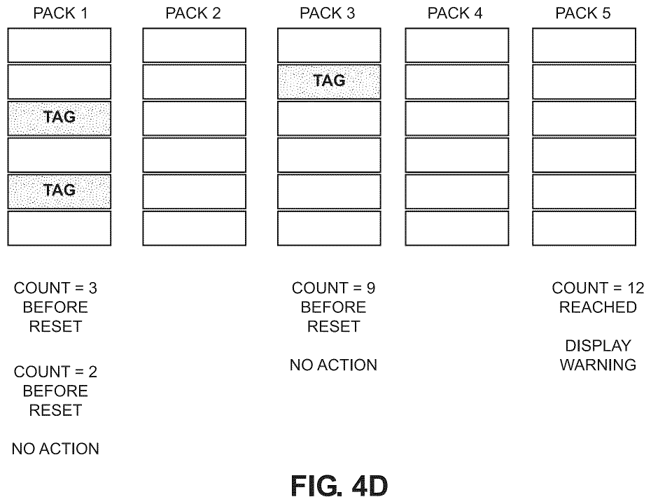

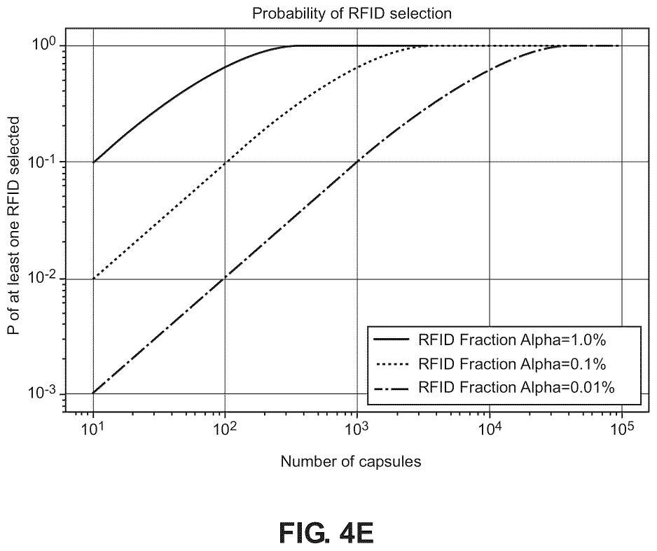

According to one or more of the example embodiments, not every capsule 1080 includes a security tag 1065. Or in other words, only a subset of capsules 1080 will include a security tag 1065 (e.g., only a subset of the capsules 1080 may be a tagged capsule). If a capsule 1080 without a security tag (e.g., a non-tagged capsule) is inserted into the aerosol generating device 1000, the security tag sensor 1060 will attempt to read, sense, and/or receive information from a security tag of the non-tagged capsule 1080 (e.g., perform a read operation of the security tag). Once the read operation fails due to the security tag not being present on the non-tagged capsule, the security tag sensor 1060 will transmit a security tag status signal to the control circuitry 1045 indicating that the capsule does not contain a security tag and/or a security tag could not be read. The methods of authenticating the security tags will be discussed in greater detail in connection with FIGS. 3 to 4E.

Additionally, the security tag 1065 may store configuration information associated with the capsule and/or the aerosol generating substrate, such as specific heating element configuration settings that correspond to the specific aerosol generating substrate contained in the capsule 1080, etc. According to some example embodiments, the security tag 1065 may further include configuration information relevant to the capsule authentication system. For example, the security tag 1065 may include information related to the number of capsules contained in a single retail capsule package (e.g., retail packaging for selling a plurality of capsules such as a capsule pack, etc.), the number of expected capsules including security tags (e.g., tagged capsules) in the retail capsule package, etc., which may be used to update the programming of the control circuitry to perform the capsule authentication method of one or more of the example embodiments.

According to some example embodiments, the aerosol generating device 1000 may further include a capsule detection switch 1070, but is not limited thereto. The capsule detection switch 1070 may be a pressure switch, a contact switch, etc., which detects the presence of the capsule 1080. For example, the capsule detection switch 1070 may be a pressure switch that is disposed within the aerosol generating device 1000. When the capsule 1080 is properly inserted into the aerosol generating device 1000, the capsule 1080 depresses, pushes, contacts, and/or triggers the capsule detection switch 1070, causing the capsule detection switch 1070 to transmit a capsule detection signal to the control circuitry 1045 of the aerosol generating device 1000. However, the example embodiments are not limited thereto, and for example, the aerosol generating device 1000 may omit the capsule detection switch 1070 and may detect the presence of the capsule via alternate and/or additional methods, such as the detection of a completion of an electrical circuit between the power source 2110b of the aerosol generating device 1000 and the capsule 1080, the detection of the insertion of the capsule 1080 based on one or more sensors associated with a hinge corresponding to a housing 1025 of the aerosol generating device 1000, and/or the detection of the insertion of the capsule 1080 based on the closing of the housing 1025 of the aerosol generating device 1000, etc., but the example embodiments are not limited thereto.

As discussed herein, an aerosol-forming substrate is a material or combination of materials that may yield an aerosol. An aerosol relates to the matter generated or output by the devices disclosed, claimed, and equivalents thereof. The material may include a compound (e.g., nicotine, cannabinoid, cannabimimetic agent) that is released when the material is heated. In such an instance, an aerosol including the compound is produced when the material is heated. The heating may be below the ignition temperature so as to avoid a self-sustaining burning or a self-sustaining combustion of the material (i.e., in contrast to where a material is lit, such as lit-end cigarettes). It is understood that heating of a material below its ignition temperature may, in some circumstances, produce incidental and insubstantial levels of oxidized or other thermal decomposition byproducts. However, in some embodiments, the heating in aerosol-generating devices is below the pyrolysis temperature of the material so as to produce an aerosol having no or insubstantial levels of thermal decomposition byproducts of the material. Thus, in an example embodiment, pyrolysis of the material does not occur during the heating and resulting production of aerosol. In other instances, there may be incidental pyrolysis, with production of oxidized or other thermal decomposition byproducts at levels that are insignificant relative to the primary constituents released by heating of the material.

The material(s) of the aerosol-forming substrate may include a fibrous material. For instance, the fibrous material may be a botanical material. The fibrous material is configured to release a compound when heated. The compound may be a naturally occurring constituent of the fibrous material. For instance, the fibrous material may be plant material such as tobacco, and the compound released may be nicotine. The term “tobacco” includes any tobacco plant material including tobacco leaf, tobacco plug, reconstituted tobacco, compressed tobacco, shaped tobacco, or powder tobacco, and combinations thereof from one or more species of tobacco plants, such as Nicotiana rustica and Nicotiana tabacum.

In some example embodiments, the tobacco material may include material from any member of the genus Nicotiana. In addition, the tobacco material may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The tobacco material may be provided in any suitable form, including, but not limited to, tobacco lamina, processed tobacco materials, such as volume expanded or puffed tobacco, processed tobacco stems, such as cut-rolled or cut-puffed stems, reconstituted tobacco materials, blends thereof, and the like. In some example embodiments, the tobacco material is in the form of a substantially dry tobacco mass. Furthermore, in some instances, the tobacco material may be mixed and/or combined with at least one of propylene glycol, glycerin, sub-combinations thereof, or combinations thereof.

The compound in the generated aerosol may also be a naturally occurring constituent of a medicinal plant that has a medically-accepted physiological effect (e.g., therapeutic effect, prophylactic effect). For instance, the medicinal plant may be a Cannabis plant or a cannabimimetic plant (i.e., a plant with similar pharmacological effects to those of Cannabis). For a Cannabis plant, the compound may be a cannabinoid. Cannabinoids interact with receptors in the body to produce a wide range of effects. As a result, cannabinoids have been used for a variety of medicinal purposes (e.g., treatment of pain, nausea, epilepsy, psychiatric disorders). The fibrous material may include the leaf and/or flower material from one or more species of Cannabis plants such as Cannabis sativa, Cannabis indica, and Cannabis ruderalis. In some instances, the fibrous material is a mixture of 60-80% (e.g., 70%) Cannabis sativa and 20-40% (e.g., 30%) Cannabis indica. For a cannabimimetic plant, the compound may be a cannabimimetic agent. Cannabimimetic agents interact with receptors in the body to produce similar pharmacological effects as cannabinoids.

Examples of cannabinoids include tetrahydrocannabinolic acid (THCA), tetrahydrocannabinol (THC), cannabidiolic acid (CBDA), cannabidiol (CBD), cannabinol (CBN), cannabicyclol (CBL), cannabichromene cannabigerol (CBC), and (CBG). Tetrahydrocannabinolic acid (THCA) is a precursor of tetrahydrocannabinol (THC), while cannabidiolic acid (CBDA) is precursor of cannabidiol (CBD). Tetrahydrocannabinolic acid (THCA) and cannabidiolic acid (CBDA) may be converted to tetrahydrocannabinol (THC) and cannabidiol (CBD), respectively, via heating. In an example embodiment, heat from a heating element may cause decarboxylation so as to convert the tetrahydrocannabinolic acid (THCA) to tetrahydrocannabinol (THC), and/or to convert the cannabidiolic acid (CBDA) to cannabidiol (CBD).

In instances where both tetrahydrocannabinolic acid (THCA) and tetrahydrocannabinol (THC) are present, the decarboxylation and resulting conversion will cause a decrease in tetrahydrocannabinolic acid (THCA) and an increase in tetrahydrocannabinol (THC). At least 50% (e.g., at least 87%) of the tetrahydrocannabinolic acid (THCA) may be converted to tetrahydrocannabinol (THC) during the heating. Similarly, in instances where both cannabidiolic acid (CBDA) and cannabidiol (CBD) are present, the decarboxylation and resulting conversion will cause a decrease in cannabidiolic acid (CBDA) and an increase in cannabidiol (CBD). At least 50% (e.g., at least 87%) of the cannabidiolic acid (CBDA) may be converted to cannabidiol (CBD) during the heating.

Furthermore, the compound which is released may be or may additionally include a non-naturally occurring additive that is subsequently introduced into the fibrous material. In one instance, the fibrous material may include at least one of cotton, polyethylene, polyester, rayon, combinations thereof, or the like (e.g., in a form of a gauze). In another instance, the fibrous material may be a cellulose material (e.g., non-tobacco and/or non-Cannabis material). In either instance, the compound introduced may include nicotine, cannabinoids, cannabimimetic agents, and/or flavorants. The flavorants may be from natural sources, such as plant extracts (e.g., tobacco extract, Cannabis extract, cannabimimetic extract), and/or artificial sources. In yet another instance, when the fibrous material includes tobacco and/or Cannabis, the compound may be or may additionally include one or more flavorants (e.g., menthol, mint, vanilla). Thus, the compound within the aerosol-forming substrate may include naturally occurring constituents and/or non-naturally occurring additives. In this regard, it should be understood that existing levels of the naturally occurring constituents of the aerosol-forming substrate may be increased through supplementation. For example, the existing levels of nicotine in a quantity of tobacco may be increased through supplementation with an extract containing nicotine. Similarly, the existing levels of one or more cannabinoids in a quantity of Cannabis may be increased through supplementation with an extract containing such cannabinoids. Likewise, the existing levels of one or more cannabimimetic agents in a quantity of cannabimimetic material may be increased through supplementation with an extract containing such cannabimimetic agents.

As discussed above, while example reference is made herein to a heat-not-burn device, the aerosol generating device may additionally or alternatively be one or more other types of devices for producing an inhalable substance from a consumable, such as, for example, an e-vapor device, a not-heated inhalable device, etc. In such instances, the aerosol-forming substrate discussed above may comprise one or more other formats, such as a pre-vapor formulation for an e-vapor device, a dispersion material for a not-heated inhalable device, etc. A pre-vapor formulation is a material or combination of materials that may be transformed into a vapor. For example, the pre-vapor formulation may be a liquid, solid, and/or gel formulation including, but not limited to, water, beads, solvents, active ingredients, ethanol, plant extracts, natural or artificial flavors, and/or vapor formers such as glycerin and propylene glycol. A dispersion material is a material or combination of materials that may be transformed into an inhalable dispersion. For example, the dispersion material may be a liquid, powder, solid, and/or gel formulation including, but not limited to, water, beads, solvents, active ingredients, ethanol, plant extracts, natural or artificial flavors, etc.

The HNB aerosol generating device and its variants may be as described in U.S. application Ser. No. 17/151,327, titled “HEAT-NOT-BURN AEROSOL-GENERATING DEVICES” Atty. Dkt. No. 24000NV-000717-US), in U.S. application Ser. No. 17/151,336, titled “A HEAT-NOT-BURN (HNB) AEROSOL GENERATING DEVICE WITH A SIDE OPENING MECHANISM, AND METHODS OF GENERATING AN AEROSOL USING THE AEROSOL GENERATING DEVICE” (Atty. Dkt. No. 24000NV-000718-US), in U.S. Design application Ser. No. 29/766,689, “HEAT-NOT-BURN AEROSOL GENERATING DEVICE WITH A FLIP-TOP LID” Atty. Dkt. No. 24000NV-000719-US), and in U.S. Design application Ser. No. 29/766,701, titled “AEROSOL GENERATING DEVICE WITH A SIDE OPENING MECHANISM” (Atty. Dkt. No. 24000NV-000720-US), the entire contents of each of which are incorporated herein by reference.

The capsule and its variants may be as described in U.S. application Ser. No. 17/151,277, titled “Capsules Including Embedded Heaters and Heat-Not-Burn (HNB) Aerosol-Generating Devices” (Atty. Dkt. No. 24000NV-000667-US), and in U.S. Design application Ser. No. 29/766,691, titled “Aerosol-Generating Capsules” (Atty. Dkt. No. 24000NV-000716-US), the entire contents of each of which are incorporated herein by reference.

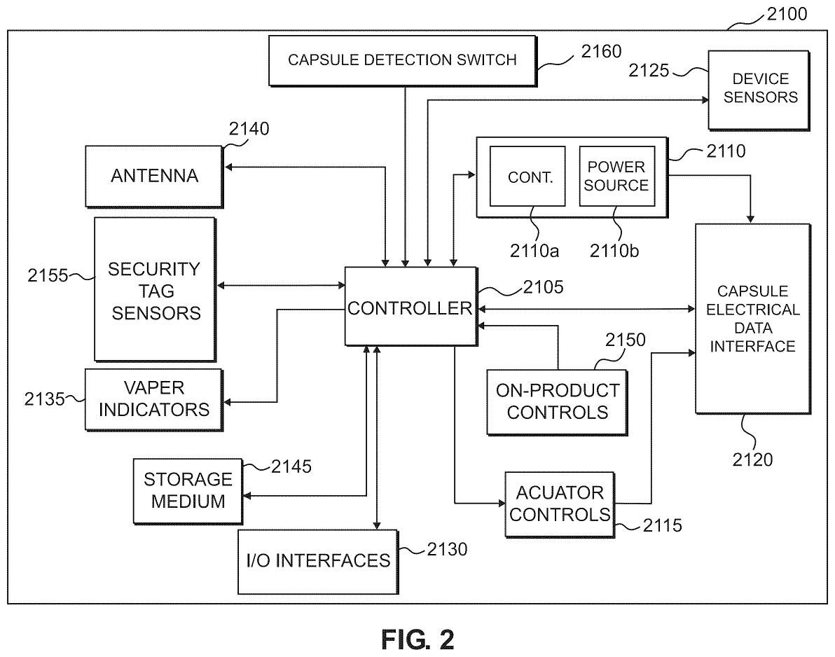

FIG. 2 is an example electric circuit diagram of an aerosol generating device according to an example embodiment.

As shown in FIG. 2, according to at least one example embodiment, a control-subsystem 2100 of an aerosol generating device, such as aerosol-generating device 1000, includes a controller 2105 (e.g., control circuitry 1045), a power supply 2110, actuator controls 2115, a capsule electrical/data interface 2120, device sensors 2125, input/output (I/O) interfaces 2130, aerosol indicators 2135, at least one antenna 2140, a storage medium 2145, at least one security tag sensor 2155 (e.g., security tag sensor 1060), and/or a capsule detection switch 2160 (e.g., capsule detection switch 1070), etc., but the example embodiments are not limited thereto. For example, the control-subsystem system 2100 may include additional elements, may omit one or more elements, and/or may combine two or more elements. However, for the sake of brevity, the additional elements are not described. In other example embodiments, the control-subsystem 2100 may not include an antenna.

The controller 2105 may be implemented as processing circuitry, e.g., hardware, hardware executing firmware, hardware executing software, or any combinations thereof. When the controller 2105 is hardware, such existing hardware may include one or more Central Processing Units (CPUs), microprocessors, processor cores, multiprocessors, digital signal processors (DSPs), application-specific-integrated-circuits (ASICs), field programmable gate arrays (FPGAs), neural processing units (NPUs), computers, or the like, configured as special purpose machines to perform the functions of the controller 2105. CPUs, microprocessors, processor cores, multiprocessors, DSPs, ASICs, FPGAs, and/or NPUs, etc., may generally be referred to as processing devices and/or processing circuitry.

In the event where the controller 2105 is, or includes, a processor executing software, the controller 2105 is configured as a special purpose machine (e.g., a processing device) to execute special purpose software, stored in memory accessible by the controller 2105 (e.g., the storage medium 2145 or another storage device), to perform the functions of the controller 2105. The software may be embodied as program code including special purpose computer readable instructions for performing and/or controlling any or all operations described herein (e.g., the operations described with respect to FIGS. 3 to 4E, etc.) as being performed by the controller 2105.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

The controller 2105 communicates with the power supply 2110, the actuator control 2115, the electrical/data interface 2120, the device sensors 2125, the input/output (I/O) interfaces 2130, the aerosol-generation indicators 2135, on-product controls 2150, the at least one antenna 2140 (e.g., radio transceiver, modem, etc.), the at least one security tag sensor 2155, and/or the capsule detection switch 2160. According to at least some example embodiments, the on-product controls 2150 can include any device or devices capable of being manipulated manually by an adult consumer to indicate a selection of a value. Example implementations include, but are not limited to, one or more buttons, a dial, a capacitive sensor, and a slider.

According to some example embodiments, the controller 2105 communicates with a cryptographic coprocessor with non-volatile memory (CC-NVM) or non-volatile memory (NVM) in the capsule 1080 through the electrical/data interface 2120, but the example embodiments are not limited thereto. The term CC-NVM may refer to a security element security tag and may be a hardware module(s) including a processor for encryption and related processing and an NVM. More specifically, the controller 2105 may utilize encryption to authenticate the capsule 1080. As will be described, the controller 2105 communicates with the CC-NVM package or NVM to authenticate the capsule 1080. More specifically, the non-volatile memory may be encoded during manufacture with product and other information for authentication.

The memory device may be encoded with an electronic identity to permit at least one of an authentication of the capsule 1080 and a pairing of operating parameters specific to a type of the capsule 1080 (or physical construction, such as a heating engine type) when the capsule 1080 is inserted into the device body housing 1025 of the aerosol generating device 1000. In addition to authenticating based on an electronic identity of the capsule 1080, the controller 2105 may authorize use of the capsule 1080 based on an expiration date of the stored aerosol generating substrate and/or heating element encoded into the NVM or the non-volatile memory of the CC-NVM. If the controller determines that the expiration date encoded into the non-volatile memory has passed (e.g., the capsule has expired), the controller may not authorize use of the capsule 1080 and disable the aerosol generating device 1000 (e.g., disable the operation of the heating element, disable power flow within the aerosol generating device 1000, disable charging of the aerosol generating device 1000, etc.). The method of authenticating a capsule will be discussed in greater detail in connection with FIGS. 3 to 4E.

The controller 2105 (or storage medium 2145) stores key material and proprietary algorithm software for the encryption. For example, encryption algorithms rely on the use of random numbers. The security of these algorithms depends on how truly random these numbers are. These numbers are usually pre-generated and coded into the processor or memory devices. One or more example embodiments may increase the randomness of the numbers used for the encryption by using the aerosol drawing parameters e.g., durations of instances of aerosol drawing, intervals between instances of aerosol drawing, or any combinations thereof, to generate numbers that are more random and/or more varying from individual to individual than pre-generated random numbers. All or some communications between the controller 2105 and the capsule 1080 may be encrypted.

The controller 2105 may also include a cryptographic accelerator to allow resources of the controller 2105 to perform functions other than the encoding and decoding involved with the authentication. The controller 2105 may also include other security features such as decreasing and/or preventing unauthorized use of communication channels and/or decreasing and/or preventing unauthorized access to data if a capsule or adult consumer is not authenticated based on a determination of the statistical probability that the capsule is authentic, etc.

In addition to a cryptographic accelerator, the controller 2105 may include other hardware accelerators. For example, the controller 2105 may include a floating point unit (FPU), a separate DSP core, digital filters and Fast Fourier Transform (FFT) modules, etc.

The controller 2105 may be configured to operate a real time operating system (RTOS), control the control subsystem 2100, etc., and may be updated through communicating with the NVM or CC-NVM or when the control subsystem 2100 is connected with other devices (e.g., a smart phone of the adult consumer, etc.) through the I/O interfaces 2130 and/or the antenna 2140. The I/O interfaces 2130 and the antenna 2140 allow the control subsystem 2100 to connect to various external devices (e.g., computing devices and/or electronic devices associated with the adult consumer, etc.), such as smart phones, tablets, smartwatches, laptops, and PCs, etc. For example, the I/O interfaces 2130 may include a USB-C connector, a micro-USB connector, etc. The USB-C connector may be used by the control subsystem 2100 to charge the power source 2110b (e.g., rechargeable battery 1035), or a separate power cable may be used, etc.

The controller 2105 may include on-board RAM and flash memory to store and execute code including analytics, diagnostics and software upgrades. As an alternative, the storage medium 2145 may store the code. Additionally, in another example embodiment, the storage medium 2145 may be on-board the controller 2105.

The controller 2105 may further include on-board clock, reset and power management modules to reduce an area covered by a PCB in the device body housing 1025 of the aerosol generating device 1000.

The device sensors 2125 may include a number of sensor transducers that provide measurement information to the controller 2105. The device sensors 2125 may include a power supply temperature sensor, an external capsule temperature sensor, a current sensor for the heating element, power supply current sensor, air flow sensor and an accelerometer to monitor movement and orientation. The power supply temperature sensor and external capsule temperature sensor may be a thermistor or thermocouple, and the current sensor for the heating element and power supply current sensor may be a resistive based sensor or another type of sensor configured to measure current. The air flow sensor (e.g., a puff sensor) may be a microelectromechanical system (MEMS) flow sensor or another type of sensor configured to measure air flow such as a hot-wire anemometer. Further, instead of, or in addition to, measuring air flow using a flow sensor included in the device sensors 2125 of the control subsystem 2100 of the device body housing 1025, air flow may be measured using a hot wire anemometer (not shown) located in the capsule 1080. According to at least one example embodiment, the device sensors 2125 further includes a capsule detection sensor 2160 for detecting the presence of the capsule 1080 in the body housing 1025, but is not limited thereto.

The data generated from one or more of the device sensors 2125 may be sampled at a sample rate appropriate to the parameter being measured using a discrete, multi-channel analog-to-digital converter (ADC).

Additionally, according to at least one example embodiment, the device sensors may further include a tag sensor, such as a radio frequency identification (RFID) sensor, a near field communication (NFC) antenna, a barcode sensor, a secure element (SE) reader, an optical reader, a physical parameter reader, etc., to detect information stored on a tag (e.g., a RFID tag, a NFC tag, a barcode tag, etc.) installed and/or attached to an exterior portion of the capsule 1080. The tag sensor may be arranged in physical proximity to a properly inserted capsule 1080 such that information stored on the tag, such as aerosol generating substrate information, expiration information, date of manufacture information, capsule security information, etc.

The controller 2105 may adapt heating element profiles (e.g., heating profiles, heater profiles, etc.) for an aerosol generating substrate and other profiles based on the measurement information received from the controller 2105. For the sake of convenience, these are generally referred to as vaping or aerosol profiles. The heating element profile identifies the power profile to be supplied to the heating element during the few seconds when aerosol drawing takes place and/or the power profile to be supplied to the heating element for the duration of the heating of an aerosol generating substrate stored in a capsule. For example, a heating element profile may cause the delivery of maximum power to the heating element when an instance of aerosol drawing is initiated, but then after a second or so immediately reduce the power to half-way or a quarter-way, etc. In another example, a heating element profile may initiate the delivery of power to the heating element and may cause adjustments to the power delivery throughout a desired time period associated with the expected duration of operation of the capsule based on vaping preferences, temperature preferences, electrical performance metrics, etc. According to at least some example embodiments, the modulation of electrical power provided to the heating element may be implemented using pulse width modulation.

In addition, a heating element profile can also be modified based on a negative pressure applied on the aerosol generating device 1000. The use of the MEMS flow sensor allows vapor drawing strength to be measured and used as feedback to the controller 2105 to adjust the power delivered to the heating element of the capsule, which may be referred to as heating or energy delivery.

According to at least some example embodiments, when the controller 2105 recognizes the capsule 1080 which is currently installed (e.g., via SKU, RFID tag, NFC tag, barcode, secure element circuitry, etc.), the controller 2105 matches an associated heating profile that is designed for that particular capsule. The controller 2105 and the storage medium 2145 will store data and algorithms that allow the generation of heating profiles for all SKUs. In at least one other example embodiment, the controller 2105 may read the heating profile from the capsule. The adult consumer may also adjust heating profiles to suit their preferences.

The controller 2105 may send data to and/or receive data from the power supply 2110. The power supply 2110 includes a power source 2110b and a power controller 2110a to manage the power output by the power source 2110b.

The power source 2110b may be a Lithium-ion battery or one of its variants, for example a Lithium-ion polymer battery. Alternatively, the power source 2110b may be a Nickel-metal hydride battery, a Nickel cadmium battery, a Lithium-manganese battery, a Lithium-cobalt battery or a fuel cell. Alternatively, the power source 2110b may be rechargeable and include circuitry allowing the battery to be chargeable by an external charging device. In that case, the circuitry, when charged, provides power for a desired (or alternatively a pre-determined) number of instances of vapor drawing and/or pre-heating of the heating element, etc., after which the circuitry must be re-connected to an external charging device.

The power controller 2110a provides commands to the power source 2110b based on instructions from the controller 2105. For example, the power supply 2110 may receive a command from the controller 2105 to provide power to the capsule (through the capsule electrical/data interface 2120) when the capsule is authenticated and the adult consumer activates the control subsystem 2100 (e.g., by activating a switch such as a toggle button, capacitive sensor, IR sensor). When the capsule is not authenticated, the controller 2105 may determine whether to allow continued operation of the aerosol generating device 1000 based on, for example, one or more of the methods discussed in connection with FIGS. 3 to 4E, etc., and based on the results of determining whether to allow continued operation. In some cases, the controller 2105 may determine to allow continued operation of the aerosol generating device 1000 in response to the capsule not being authenticated, and may display and/or otherwise communicate a warning message to the adult consumer indicating that the capsule was not authenticated (e.g., a message indicating that the capsule may be counterfeit, damaged, tampered with, manufactured by an unauthorized manufacturer, etc.) on a display device and/or speaker included on the aerosol generating device 1000 and/or transmit the warning message for a display on the connected computing device and/or an electronic device associated with the adult consumer, etc. In some cases, the controller 2105 may determine to not allow continued operation of the aerosol generating device 1000 in response to the capsule not being authenticated, and may either send no command to the power supply 2110 or send an instruction to the power supply 2110 to not provide power, with or without displaying the warning message on the display device included in the aerosol generating device 1000 and/or transmitting the warning message to the connected computing device and/or electronic device. In another example embodiment, the controller 2105 may disable all operations of the control subsystem 2100 if the capsule is not authenticated and the results indicate not to allow continued operation of the aerosol generating device 1000.

In addition to supplying power to the capsule, the power supply 2110 may also supply power to the controller 2105. Moreover, the power controller 2110a may provide feedback to the controller 2105 indicating performance of the power source 2110b.

The controller 2105 sends data to and receives data from the at least one antenna 2140 and/or at least one security tag sensor 2155. The at least one antenna 2140 may include a NFC modem and/or RFID modem and a Bluetooth Low Energy (LE) modem and/or other modems for other wireless technologies (e.g., Wi-Fi). In an example embodiment, the communications stacks are in the modems, but the modems are controlled by the controller 2105. The Bluetooth LE modem is used for data and control communications with an application on an external device (e.g., smart phone). The NFC and/or RFID modem may be used for pairing of the aerosol generating device 1000 to the application and retrieval of diagnostic information. Moreover, the Bluetooth LE modem may be used to provide location information (for an adult consumer to find the aerosol generating device 1000) or authentication during a purchase.

Additionally, the NFC modem and/or RFID modem may also be used as the security tag sensor 2155 to read information stored on at least one security tag of a capsule. The at least one security tag sensor 2155 may further include a barcode reader, an optical reader, and/or a physical parameter measurement sensor (e.g., heating element resistance measurement circuitry, etc.), or any combinations thereof, for use in reading information from and/or detecting security tags on a capsule, but the example embodiments are not limited thereto.

As described above, the control-subsystem 2100 may generate and adjust various profiles for vaping. The controller 2105 uses the power supply 2110 and the actuator controls 2115 to regulate the profile for the adult consumer.

The actuator controls 2115 may include passive and/or active actuators to regulate a desired aerosol profile. For example, the device body 1025 may include an inlet channel within a mouthpiece. The actuator controls 2115 may control the inlet channel based on commands from the controller 2105 associated with the desired vapor profile.

Moreover, the actuator controls 2115 are used to energize the heating element in conjunction with the power supply 2110. According to at least one example embodiment, the actuator controls 2115 are configured to generate a drive waveform associated with the desired vaping profile. As described above, each possible profile is associated with a drive waveform. Upon receiving a command from the controller 2105 indicating the desired aerosol profile, the actuator controls 2115 may produce the associated modulating waveform for the power supply 2110.

The controller 2105 supplies information to the aerosol indicators 2135 to indicate statuses and occurring operations to the adult consumer. The indicators 2135 include a power indicator (e.g., LED) that may be activated when the controller 2105 senses a button pressed by the adult consumer. The indicators 2135 may also include a vibrator, speaker, an indicator for a current state of an adult consumer-controlled aerosol parameter (e.g., generated aerosol volume) and other feedback mechanisms.

While FIGS. 1 to 2 depict example embodiments of a heat-not-burn (HNB) aerosol generating device, the HNB aerosol generating device is not limited thereto, and may include additional and/or alternative hardware configurations that may be suitable for the purposes demonstrated. For example, the HNB aerosol generating device may include a plurality of additional or alternative elements, such as additional or alternative heating elements, reservoirs, batteries, etc. Additionally, while FIGS. 1 to 2 depict the example embodiment of the HNB aerosol generating device as being embodied in a single housing element, additional example embodiments may be directed towards a HNB aerosol generating device arranged in two or more housing elements, etc.

FIG. 3 is a flowchart illustrating an example method of statistically authenticating a capsule containing an aerosol generating substrate according to some example embodiments.

According to at least one example embodiment, in operation S310, a HNB aerosol generating device (e.g., the aerosol generating device 1000 of FIG. 1, etc.) may detect the insertion of a capsule (e.g., capsule 1080) into a housing (e.g., body 1025) of the aerosol generating device. For example, the aerosol generating device may detect the insertion of the capsule based on the completion of an electrical circuit between the battery of the aerosol generating device and the capsule, may detect the insertion of the capsule based on a capsule detection signal received from a capsule detection switch (e.g., capsule detection switch 1070), may detect the insertion of the capsule based on one or more sensors associated with a hinge corresponding to the housing of the aerosol generating device to detect a closing of the housing of the aerosol generating device, etc., but the example embodiments are not limited thereto.

Additionally, according to some example embodiments, in operation S310 the aerosol generating device may alternatively, or additionally, detect the activation of the aerosol generating device. For example, the aerosol generating device may omit the detection of the insertion of the capsule and may instead proceed to operation S320 based on the detection of the activation of the aerosol generating device based on, for example, the detection of negative air pressure being applied to the mouthpiece of the aerosol generating device using, for example, a flow sensor/puff sensor, etc., and/or the detection of a power button and/or consumer engagement button of the aerosol generating device.

However, the example embodiments are not limited thereto, and either the detection of the insertion of the capsule or the activation of the aerosol generating device, or both, may cause the aerosol generating device to proceed to operation S320.

In operation S320, the aerosol generating device determines whether a capsule inserted into and/or installed in the aerosol generating device includes at least one authentic security tag using at least one security sensor of the aerosol generating device. According to some example embodiments, a security tag is attached, installed, embedded, printed, etc. onto an exterior housing of the capsule, and may be at least one of a RFID tag, a NFC tag, a barcode (e.g., 1D barcode, a 2D barcode, a QR code, an encrypted barcode, etc.), an optical security tag (e.g., an ultra-violet (UV) taggant, an infra-red (IR) taggant, microdots, a hologram, a security thread, a 3D security ribbon, a watermark, color-shifting ink, a microprint, a spare out, a variable image, anti-tamper slits, a hologram, a thermal ink, a hot stamping foil, or intentional misspellings, etc.), secure element circuitry, a physical parameter measurement, or any combinations thereof.

According to some example embodiments, the security sensor may be at least one of a RFID modem, a NFC transceiver, a barcode reader, an optical reader, a physical parameter measurement circuitry (e.g., heating element resistance measurement circuitry, etc.), or any combinations thereof, corresponding to the security tag installed on the capsule, or vice versa. Upon receiving the capsule detection signal, the control circuitry will control the at least one security sensor to attempt to sense at least one security tag and/or read the contents of the at least one security tag included in the installed capsule. If the security tag is not present on the capsule and/or the control circuitry is not able to properly authenticate the security tag, the control circuitry determines that the capsule fails the security tag check operation (e.g., no authentic security tag was detected). If the security sensor detects and properly reads the security tag and the control circuitry is able to authenticate the contents of the security tag, the control circuitry determines that the capsule has passed the security tag check operation (e.g., an authentic security tag was detected). According to some example embodiments, the control circuitry may store a unique identifier stored in the read security tag in the memory of the aerosol generating device, and may compare the stored unique identifier with the unique identifiers read from security tags inserted into the aerosol generating device in the future to determine if an attempt has been made to re-install and/or re-use the authentic security tag in a different capsule, and/or re-use a capsule which contains the authentic security tag in order to reset the security tag counter (e.g., defeat the security check operation, etc.). In the event that a re-use of an authentic security tag is detected, the control circuitry may declare that the unique identifier associated with the re-used security tag is inauthentic and the method may immediately proceed to operation S350 and/or operation S355, but the example embodiments are not limited thereto. For example, in at least one example embodiment, if the re-use of an authentic security tag is detected, the control circuitry may skip operation S530 entirely and proceed directly to operation S355.

In response to the inserted capsule failing the security check operation by the aerosol generating device in operation S320 after the capsule has been inserted into the aerosol generating device, the method proceeds to operation S330. In operation S330, the aerosol generating device increments a count (e.g., a count value) of a counter (e.g., a security tag counter, a first counter, etc.) residing in the memory of the aerosol generating device.

In operation S340, the aerosol generating device may determine a statistical probability of the inserted capsule being authentic based on the current count of the counter and a desired first threshold setting (e.g., a warning threshold value, etc.) corresponding to the capsule. For example, if the count of the counter has not exceeded (e.g., is below) the desired first threshold setting, then the aerosol generating device determines that the capsule is statistically likely to be authentic (e.g., the capsule is statistically unlikely to be counterfeit/damaged/tampered with/manufactured by an unauthorized manufacturer, etc.). If the count of the counter exceeds the desired first threshold setting, the aerosol generating device determines that the capsule is statistically unlikely to be authentic (e.g., is statistically likely to be a counterfeit product, etc.). The desired first threshold setting (e.g., a first threshold value, a warning threshold value, etc.) may be set by the manufacturer of the capsules and/or the aerosol generating device, but is not limited thereto. The desired first threshold setting will be discussed in greater detail in connection with FIG. 4A.

In response to the aerosol generating device determining the inserted capsule is statistically likely to be authentic, the aerosol generating device proceeds to operation S370.

If the aerosol generating device determines that the capsule is statistically unlikely to be authentic based on the results of the determination of operation S340, in operation S350, the aerosol generating device may display a warning message to the adult consumer indicating that the capsule is likely to be inauthentic, counterfeit, tampered with, etc. According to some example embodiments, the warning message may further include instructions on how the adult consumer may personally determine if the capsule and/or the retail packaging is counterfeit, inauthentic, tampered with, etc., how to report the counterfeit capsule, how to request a refund, etc. For example, the warning message may be displayed on a display panel included in the aerosol generating device, may be displayed using a designated warning indicator light of the aerosol generating device, may be transmitted to a connected computing device and/or electronic device of the adult consumer (e.g., a smartphone, tablet, PC, laptop, etc., of the adult consumer) via email, messaging application, social media account message, SMS message, and/or a companion software application (e.g., a companion app), etc., associated with the aerosol generating device installed on the computing device and/or electronic device, or any combinations thereof. Additionally, in some example embodiments, the aerosol generating device may further include a haptic feedback device (e.g., a haptic feedback motor, etc.), which may provide a designated vibration pattern to indicate that the capsule is counterfeit, inauthentic, damaged, tampered with, etc.

According to some example embodiments, the aerosol generating device may continue to allow the operation of the heating element (operation S370) after providing the warning message to the adult consumer. Moreover, according to some example embodiments, the aerosol generating device may request and/or require that the adult consumer provide a user input (e.g., a button press on the button of the aerosol generating device, a mouse click/keyboard input/touch operation responsive to the warning message on the computing device and/or electronic device, a responsive reply message to a warning SMS message/email/instant message, etc.) to acknowledge that the warning message has been read before allowing the continued operation of the aerosol generating device (operation S370). Additionally, according to some example embodiments, a second counter (e.g., a warning counter, etc.) may be incremented in operation S350.

Further, in optional operation S355, the aerosol generating device may disable (e.g., prohibit and/or prevent) the battery from supplying power (e.g., electrical current) to the heating element based on the results of operation S340 and a second desired threshold setting, but the example embodiments are not limited thereto. More specifically, according to some example embodiments, the aerosol generating device may disable the battery from supplying power (e.g., electrical current) to the heating element in response to the current count of the counter (e.g., the first counter) exceeding a second desired threshold setting (e.g., a second threshold value, a disable operation threshold value, etc.), wherein the second desired threshold setting has a value greater than the value of the first desired threshold setting. According to some example embodiments including the second counter, the aerosol generating device may disable the battery from supplying power to the heating element in response to the current count of the second counter and the second desired threshold setting. If the count of the counter (e.g., the first counter if only the first counter is present, or the second counter if two counters are present) is less than the second desired threshold setting, the method returns to operation S310. The second desired threshold setting will be discussed in greater detail in connection with FIG. 4A. However, the example embodiments are not limited thereto, and for example, the second desired threshold setting may be omitted or may be set to have the same value as the first desired threshold setting. In this example, the aerosol generating device may omit the disabling operation and only provide a warning to the adult consumer, or the aerosol generating device may omit the warning to the adult consumer and may immediately disable the heating element, etc.

Returning to operation S320, if the aerosol generating device detects the presence of a desired security tag on the capsule and/or properly authenticates the desired security tag in operation S320, according to some example embodiments, in operation S360, the aerosol generating device resets the count of the counter (e.g., sets the first counter to zero, etc.). Additionally, in the example embodiments where a second counter is implemented, the count of the second counter may also be reset.

In operation S370, in response to the determination that the capsule is statistically likely to be authentic (and/or the capsule is statistically unlikely to be counterfeit), the aerosol generating device enables the powering of the heating element (e.g., heater, resistive heating element, inductive heating coil, etc.) of the aerosol generating device and/or the capsule (e.g., enable current to flow from the battery of the aerosol generating device to the heating element of the aerosol generating device and/or capsule, etc.).

FIG. 4A is a flowchart illustrating an example method of distributing and packaging security tagged capsules to at least one capsule package according to some example embodiments. FIG. 4B illustrates a first example method of distributing security tags according to FIG. 4A. FIG. 4C illustrates a second example method of distributing security tags according to FIG. 4A. FIG. 4D illustrates a third example method of distributing security tags according to FIG. 4A, and FIG. 4E illustrates example probability curves associated with the third example method of FIG. 4D. While FIGS. 4B to 4E are illustrated using specific numeric values for certain variables for the sake of clarity and brevity, the example embodiments are not limited thereto, and other suitable numeric values may be implemented as well.

According to at least one example embodiment, each retail package (e.g., capsule package, distribution packaging, commercial packaging, etc.) will include the same number of capsules, and for the present example embodiments, the number of capsules per package is assumed to be six HNB capsules, e.g., M=6, where M equals the total number of capsules included in a single package. However, the example embodiments are not limited thereto and any whole number may be used for M, or in other words, a retail package may include a greater or lesser number of capsules.

Referring now to FIG. 4A, in operation S341, a first desired threshold setting (e.g., the warning threshold value, etc.) and/or a second desired threshold setting (e.g., the disable operation threshold value, etc.) is/are set based on an expected and/or planned distribution of capsules including security tags (e.g., tagged capsules) in each retail package. The methodology for determining the first desired threshold setting and/or the second desired threshold setting may vary based on the planned distribution of tagged capsules in the retail package(s), and some example distribution methods according to some non-limiting example embodiments are illustrated in FIGS. 4B to 4E. According to some example embodiments, when there is a change in the planned distribution of tagged capsules included in a retail package and/or when there is a change in the number of total capsules to be included in a retail package, the manufacturer may transmit software updates for the first desired threshold setting and/or the second desired threshold setting to the aerosol generating device, for example, via instructions stored in the security tag, via the wired and/or wireless connection of the aerosol generating device, etc.

A first example tagged capsule distribution method is shown in FIG. 4B. In FIG. 4B, the planned distribution method (e.g., distribution scheme, tagged capsule distribution scheme, packaging scheme, etc.) includes a single capsule in a desired position (e.g., a first position, etc.) in each retail package being the tagged capsule, and every other remaining capsule in the retail package being a non-tagged capsule (e.g., a second to sixth positions, etc.). For example, during the manufacturing and/or packaging of a retail package of capsules, at least one tagged capsule is selected from a first pool of capsules (e.g., a set of tagged capsules, etc.), and a plurality of non-tagged capsules are selected from a second pool of capsules (e.g., a set of non-tagged capsules, etc.). The at least one tagged capsule is inserted into a desired position in each retail package, such as a first capsule position in each retail package, during the production of the retail package, and every other position in the same retail package is filled with a non-tagged capsule. In other words, the tagged capsule is positioned and/or arranged in the retail package such that an adult consumer installs the tagged capsule first, etc., and the non-tagged capsules are positioned and/or arranged in the remaining positions of the retail package. This first example may be referred to as a “guaranteed tagged capsule” distribution method, and at least one capsule of the plurality of capsules included in the retail package of capsules is expected and/or guaranteed to include a security tag. Additionally, the example embodiments are not limited to inclusion of a single tagged capsule in a retail package, and for example, two or more tagged capsules may be included in a retail package in two or more known capsule positions of the retail package during the production of the retail package. Moreover, the tagged capsule(s) are not limited to the first capsule position of the retail package, but instead may be placed in other desired, known, and/or predetermined position(s) in the retail package.

The first desired threshold setting (e.g., the warning threshold value and/or the threshold value where a warning message is displayed to the adult consumer, etc.) for this first example is set using the following formula:

T1=M/N [Equation 1]

where T1 is the first desired threshold setting, M is the total number of capsules included in a package, and N is the total number of tagged capsules in the package. M and N may both be any natural number greater than zero and M>=N.

In this example, because the number of tagged capsules is one, e.g., N=1, and the total number of capsules in a single package is six, e.g., M=6, the first desired threshold setting is 6. If N is set to 2 and M is set to 6, the first desired threshold setting would be 3, etc.

Additionally, the second desired threshold setting (e.g., the disable threshold value, etc.) for the first example is set based on the following formula:

T2=(2×M)/N [Equation 2]

where T2 is the second desired threshold setting.

In this example, the second desired threshold setting is set to 12 (e.g., (2×6)/1), but the example embodiments are not limited thereto. For example, if N is set to 2 and M is set to 6, the second desired threshold setting would be 6, etc.

According to at least one example embodiment, the first desired threshold setting and the second desired threshold are set in this manner to account for potential manufacturing and/or production errors in the genuine security tags included in the tagged capsule, potential production errors in the distribution of tagged capsules in a genuine retail package, and/or potential unexpected adult consumer behavior wherein the adult consumer does not install the first capsule (e.g., the tagged capsule) of the genuine retail package into the aerosol generating device first, the adult consumer loses the first capsule (e.g., the tagged capsule), the adult consumer installs the first capsule (e.g., the tagged capsule) in a different aerosol generating device etc. However, because it is statistically improbable that two consecutive genuine retail packages bought by an adult consumer would be missing a genuine tagged capsule and/or the security tag of the genuine tagged capsule would be damaged or have any other type of error, the second threshold setting increases the likelihood that the installation of counterfeit capsules from one or more inauthentic capsule packages in the aerosol generating device will be detected, stopped and/or prohibited.

The guaranteed tagged capsule distribution method provides for a decrease in manufacturing costs of the capsules in comparison to conventional security/authentication methods for aerosol generating devices, wherein every capsule (e.g., cartridge, consumable, etc.) of the conventional method would be tagged with a security device by decreasing the number of capsules tagged with security devices. Additionally, the guaranteed tagged capsule distribution method further accounts for potential defects and/or errors in the production of security tags and/or the reading of the security tags by the security tag sensor by only providing a warning if the first threshold value is exceeded, and disabling the operation of the aerosol generating device when the second threshold value is exceeded. This is in contrast to conventional authentication methods for capsules wherein if a single capsule has a defective security tag and/or an authentic security tag was incorrectly read due to external factors (e.g., the capsule being improperly installed/aligned within the aerosol generating device, the security tag being obscured, impeded, damaged, etc.) then the conventional aerosol generating device would immediately stop operation, thereby decreasing adult consumer dissatisfaction and frustration and/or increasing adult consumer satisfaction. Moreover, the guaranteed tagged capsule distribution method also guarantees that configuration updates included in a security tag are obtained in a timely manner by the aerosol generating device.

A second example tagged capsule distribution method is shown in FIG. 4C. In FIG. 4C, the planned distribution method may be referred to as a “random distribution” method and includes a random distribution of a single tagged capsule in each retail package, with every other remaining capsule in the retail package being a non-tagged capsule (e.g., a capsule which does not include the at least one security tag). Similar to the first example tagged capsule distribution method, each retail capsule package is expected and/or guaranteed to include at least one tagged capsule, but the second example differs from the first example in that the tagged capsule is not located in the same position in each package (e.g., the tagged capsule is randomly distributed in the retail packages, etc.). The random distribution method example may provide additional security over the guaranteed distribution method by randomizing the placement of the tagged capsule within each retail package, thereby decreasing and/or avoiding the possibility of theft of the tagged capsule from a retail package by making it more difficult for an unauthorized person to determine which capsule in a retail package contains the security tag. Additionally, the randomized placement of the tagged capsule may decrease the re-use of a tagged capsule by making it more difficult for an unauthorized person to determine whether a specific capsule contains the security tag.

Additionally, the example embodiments are not limited to use of a single tagged capsule in a retail package for the random distribution method, and for example, two or more tagged capsules may be included in a single retail package, etc.

According to at least one example embodiment, the first desired threshold setting (e.g., the warning threshold value and/or the threshold value where a warning message is displayed to the adult consumer, etc.) for the second example is set using the following formula:

T1=((2××M)−1)/N [Equation 3]

In this example, if N=1, and M=6, the first desired threshold setting is 11. If the first desired threshold setting is not a whole number, for example if N is set to 2 and M is set to 6, a ceiling function is performed on the first desired threshold setting to set the first desired threshold setting to a next whole number (e.g., the first desired threshold setting is rounded up), such as 6, etc.

Additionally, the second desired threshold setting (e.g., the disable threshold value, etc.) for the second example is set based on the following formula:

T2=((3×M)−1)/N [Equation 4]

In this example, if N=1, and M=6, the second desired threshold setting is set to 17, but the example embodiments are not limited thereto. If the second desired threshold setting results is not a whole number, e.g., if N is set to 2 and M is set to 6, a ceiling function may be performed on the second desired threshold setting, or in other words, the second desired threshold setting is rounded up to 9, etc., but is not limited thereto.

Similar to the advantages of the first distribution method example, the first desired threshold setting and the second desired threshold are set in this manner to account for potential manufacturing and/or production errors in the security tags included in the genuine tagged capsule, potential production errors in the distribution of tagged capsules in a genuine retail package, and decreasing the cost of adding security features to capsules by not requiring that every capsule include a security feature. The second distribution method has the additional benefits of not requiring the adult consumer to install the capsules of a genuine retail package in a particular order, and reducing the manufacturing complexity of the genuine retail package by not requiring the tagged capsule to be included in the same position in each genuine retail package.

A third example tagged capsule distribution method is shown in FIGS. 4D to 4E. In FIG. 4D, the planned distribution method may be referred to as a “statistical distribution” method and includes a random distribution of a plurality of tagged capsules throughout a plurality of genuine retail packages (e.g., a carton including a plurality of retail packages, a set of retail packages, and/or a universe of retail packages, etc.) instead of a set number of tagged capsules being inserted and/or distributed into each genuine retail package (e.g., a defined distribution of tagged capsules on a per-pack basis). Accordingly, in further contrast to the first and second examples shown in FIGS. 4B and 4C, not every genuine retail package in the statistical distribution method is expected and/or guaranteed to include a tagged capsule, and some genuine retail packages may have more than one tagged capsule.

More specifically, for the statistical distribution method, a distribution ratio α (where 0.0<=α<=1.0) may be selected by the manufacturer which represents a ratio of tagged capsules that are included in a total population of capsules n (e.g., the sum of the tagged and untagged capsules) that are randomly distributed into a plurality of genuine retail packages, where α=1.0 if every capsule of the set of capsules n is a tagged capsule, and α=0.0 if zero capsules in the set of capsules n are tagged capsules. Additionally, a probability β may be set by the manufacturer, wherein β represents the probability that a genuine capsule inserted into an aerosol generating device is a tagged capsule out of the total population of capsules n. β may be derived from a joint probability of independent identically distributed (i.i.id) variables via a Binomial probability distribution. According to at least one example embodiment, β may be determined using the following equation:

β=1−(1−α)ⁿ [Equation 5]

In other words, β is the probability of finding a tagged capsule out of n genuine capsules inserted into the aerosol generating device. The probability β may also be referred to as the confidence level that a tagged capsule is detected by the aerosol generating device after sampling n genuine capsules with a distribution ratio of α.

Referring now to FIG. 4E, three probability curves for the probability β are shown, wherein each probability curve β is based on a different α. The first probability curve β corresponds to an α value of 0.01 and a n value of 100, e.g., there is 1 tagged capsule in every 100 genuine capsules, or in other words 1% of genuine capsules include at least one security tag. The second probability curve β corresponds to an α value of 0.001 and a n value of 1,000, e.g., there is 1 capsule in every 1,000 genuine capsules, or in other words 0.1% of genuine capsules includes at least one security tag. The third probability curve β corresponds to an α value of 0.0001 and an n value of 10,000, e.g., there is 1 tagged capsule in every 10,000 genuine capsules, or in other words 0.01% of genuine capsules include at least one security tag. However, the example embodiments are not limited thereto, and the α, β, and/or n values may vary.

According to some example embodiments, the distribution ratio α may be set to a number less than 1, and for example, the distribution ratio α may be set such that the number of tagged capsules is expected to be less than 1 tagged capsule in each genuine retail package, thereby further reducing the manufacturing costs associated with the statistical distribution method in comparison to the guaranteed tagged capsule distribution method and the random distribution method, but the example embodiments are not limited thereto. For example, as shown in FIG. 4D, it is assumed that each genuine retail package contains 6 capsules, so an α value of 0.143 may be selected so that it is expected that 1 in 7 genuine capsules will contain a security tag, but the example embodiments are not limited thereto.

According to at least one example embodiment, the first desired threshold setting (e.g., the warning threshold value, etc.) for the third example may be set using the following formula:

T1=ceiling((1/α)/M)×M [Equation 6]

In this example, if α=0.143 and M=6, the first desired threshold setting is 12, since each genuine retail package contains 6 capsules and it is assumed that the capsules are randomly distributed and/or packed into each genuine retail package, the aerosol generating device will have to sample at least two genuine retail packages (e.g., 12 capsules) before a tagged capsule is statistically expected to be detected.

In this example, the confidence level β is 84%. However, the first desired threshold setting may be adjusted by multiplying the first desired threshold setting by a desired multiple as shown in Equation 7 in order to increase the confidence level β such that a warning message is not displayed so that the adult consumer is statistically unlikely to have received a tagged capsule in a genuine retail package.

T1=(ceiling((1/α)/M)×M)×P [Equation 7]

Where P corresponds to the desired multiple and is a whole number.

For example, if α=0.143 and M=6, P may be set to 2, so the first desired threshold setting is 24 (e.g., 4 retail packages), which results in a confidence level β of 97.5%. As another example, if α=0.143 and M=6, P may be set to 5, which results in a first desired threshold setting of 60 (e.g., 10 retail packages, which may be the equivalent to a carton of retail packages, etc.), and would result in a confidence level β of 99.99%.

According to this example embodiment, the second desired threshold setting may be omitted, and the aerosol generating device may display the warning message based on the counter exceeding the first desired threshold setting. Alternatively, the second desired threshold setting may be set to a multiple of M that is higher than the first desired threshold setting, as shown below:

T2=T1+(M×Q) [Equation 8]

Where Q corresponds to a second desired multiple and is a whole number.

For example, if T1=24 and Q=2, then the second desired threshold setting is 36, but the example embodiments are not limited thereto.

The statistical capsule distribution method provides for a further reduction in manufacturing costs of the capsules in comparison to conventional security/authentication methods for aerosol generating devices and the first distribution method and the second distribution method, by requiring less tagged capsules to while providing a very high statistical probability of triggering a warning message and/or other remedial action (e.g., disabling the operation of the aerosol generating device, etc.) only when a counterfeit and/or otherwise improper capsule is installed in the aerosol generating device. Further, the statistical capsule distribution method may also reduce production costs by reducing the complexity of the packaging process in comparison to the first and second distribution methods which guarantee at least one tagged capsule is included in each retail package, by having a single batch of tagged and untagged capsules representing the population of capsules to be inserted into the plurality of retail packages and randomly selecting capsules from the entire population of capsules to be inserted into a particular retail package.

While FIGS. 4B to 4E depict example embodiments for determining a first desired threshold setting and/or a second desired threshold setting, the example embodiments are not limited thereto, and other methods of determining the first desired threshold setting and/or the second desired threshold setting which may be suitable for the purposes demonstrated may be used. For example, in at least one example embodiment, the first counter and/or the second counter may be omitted, and instead, a database and/or table may store a list of the last X capsules (e.g., X=32 capsules, etc.) inserted into the aerosol generating device 1000 and an indication of whether the X capsules were tagged capsules or not. Statistical analysis may be performed on the records included in the database and/or table, such as the statistical analysis discussed in connection with FIGS. 4B to 4D, but not limited thereto, to determine whether any gaps (e.g., absences of tagged capsules, etc.) included in the records of the database and/or table corresponded to a normal distribution of tagged capsules or not.

Returning to FIG. 4A, in operation S342, at least one retail package may be packaged during manufacturing and/or production (e.g., at a manufacturing plant, etc.), based on the set number of tagged capsules, set number of non-tagged capsules, and the total number of capsules per retail package as determined based on the set first desired threshold value and/or the set second desired threshold value in operation S341. According to some example embodiments, the number of tagged capsules may be equal to or less than the number of retail packages, but the example embodiments are not limited thereto.

In operation S343, a plurality of tagged capsules may be stored in at least one first storage bin (e.g., first set, etc.) and a plurality of non-tagged capsules may be stored in at least one second storage bin (e.g., second set, etc.), and employees and/or assembly line robots, machinery, etc., may insert and package the tagged capsules and non-tagged capsules into each retail package based on the desired distribution method used.

As a first example, if the first distribution method as shown in FIG. 4B is employed, each retail package may have one tagged capsule inserted in a first position of the retail package, and may have five non-tagged capsules inserted in the second to sixth positions of the retail package. As a second example, if the second distribution method as shown in FIG. 4C is employed, each retail package may have one tagged capsule inserted into a random position in each retail package, and may have five non-tagged capsules inserted into the remaining positions of the retail package. As a third example, a random number of tagged capsules may be selected for insertion into random positions of a retail package, and the remaining positions of the same retail package are filled using the non-tagged capsules. For the third example, the tagged capsules and the non-tagged capsules may be stored in a same storage bin (e.g., a bowl feeder), and randomly mixed together, etc. For example, the tagged capsules and the non-tagged capsules may be stored in a bowl feeder and may be fed into each retail package in an assembly line process, etc.

Some example embodiments described provide systems, apparatuses, methods, and/or non-transitory computer readable media related to statistical applications of security tags in authenticating a capsule, particularly in authenticating capsules compatible with an aerosol generating device, such as a heat-not-burn (HNB) device. One or more example embodiments may reduce the manufacturing costs of retail packages including capsules, while providing a statistically high probability level of detecting installation of counterfeit and/or otherwise improper capsules.

Some example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

Illustrative Embodiment 1. An aerosol generating device comprising: a housing configured to receive a capsule, the capsule containing an aerosol-forming substrate; a heating element configured to heat the aerosol-forming substrate to generate an aerosol; and control circuitry configured to, determine whether the received capsule includes at least one security tag using at least one security sensor, increment a counter based on results of the determining whether the received capsule includes the at least one security tag, and determine a statistical probability of authenticity of the received capsule based on a count of the counter and a first desired threshold value.

Illustrative Embodiment 2. The aerosol generating device of illustrative embodiment 1, wherein the received capsule is provided in a retail package of capsules; the retail package of capsules includes a plurality of capsules including the received capsule; and a single capsule of the plurality of capsules included in the retail package of capsules includes the at least one security tag.

Illustrative Embodiment 3. The aerosol generating device of any one of illustrative embodiments 1-2, wherein the control circuitry is further configured to: increment the counter in response to the results of the determining whether the received capsule includes the at least one security tag indicating an absence of the at least one security tag from the received capsule; and resetting the counter in response to the results of the determining whether the received capsule includes the at least one security tag indicating a presence of the at least one security tag in the received capsule.

Illustrative Embodiment 4. The aerosol generating device of any one of illustrative embodiments 1-3, wherein the first desired threshold value corresponds to a maximum number of capsules included in a retail package of capsules, the retail package of capsules including a plurality of capsules.

Illustrative Embodiment 5. The aerosol generating device of any one of illustrative embodiments 1-4, wherein the first desired threshold value is set according to 2N−1, wherein N is a maximum number of capsules included in a retail package of capsules, the retail package of capsules including a plurality of capsules.

Illustrative Embodiment 6. The aerosol generating device of any one of illustrative embodiments 1-5, wherein the first desired threshold value is set based on a distribution ratio of capsules including the at least one security tag and a desired confidence level of detecting a capsule including the at least one security tag.

Illustrative Embodiment 7. The aerosol generating device of any one of illustrative embodiments 1-6, wherein a first capsule included in a retail package of capsules is guaranteed to include the at least one security tag.

Illustrative Embodiment 8. The aerosol generating device of any one of illustrative embodiments 1-7, wherein a randomly selected capsule included in each retail package of capsules includes the at least one security tag.

Illustrative Embodiment 9. The aerosol generating device of any one of illustrative embodiments 1-8, wherein a plurality of security tags are randomly distributed among a plurality of capsules included in a plurality of retail packages of capsules; and no retail package of the plurality of retail packages is guaranteed to include a capsule including the security tag of the plurality of security tags.

Illustrative Embodiment 10. The aerosol generating device of any one of illustrative embodiments 1-9, further comprising: a display panel; and wherein the control circuitry is further configured to: display a warning message to an adult consumer on the display panel based on the determined statistical probability of authenticity of the capsule.

Illustrative Embodiment 11. The aerosol generating device of any one of illustrative embodiments 1-10, wherein the control circuitry is further configured to: transmit a warning message to an electronic device associated with an adult consumer based on the determined statistical probability of authenticity of the received capsule.

Illustrative Embodiment 12. The aerosol generating device of any one of illustrative embodiments 1-11, wherein the control circuitry is further configured to: disable power to the heating element in response to the determined statistical probability of authenticity indicating the capsule is not authentic.

Illustrative Embodiment 13. The aerosol generating device of any one of illustrative embodiments 1-12, wherein the control circuitry is further configured to: disable power to the heating element in response to the count of the counter exceeding a second desired threshold value.

Illustrative Embodiment 14. The aerosol generating device of illustrative embodiment 13, wherein the second desired threshold value is greater than the first desired threshold value.

Illustrative Embodiment 15. The aerosol generating device of any one of illustrative embodiments 13-14, wherein the second desired threshold value is equal to the first desired threshold value.

Illustrative Embodiment 16. The aerosol generating device of any one of illustrative embodiments 1-15, wherein the aerosol generating device is a heat-not-burn aerosol generating device.

Illustrative Embodiment 17. The aerosol generating device of any one of illustrative embodiments 1-16, wherein the aerosol generating device is an e-vapor aerosol generating device.

Illustrative Embodiment 18. A method of operating an aerosol generating device, the method comprising: determining whether a capsule received by the aerosol generating device includes at least one security tag using at least one security sensor, the capsule containing an aerosol-forming substrate; incrementing a counter based on results of the determining whether the received capsule includes the at least one security tag; and determining a statistical probability of authenticity of the received capsule based on a count of the counter and a first desired threshold value.

Illustrative Embodiment 19. The method of illustrative embodiment 18, wherein the received capsule is provided in a retail package of capsules; the retail package of capsules includes a plurality of capsules including the received capsule; and a single capsule of the plurality of capsules included in the retail package of capsules includes the at least one security tag.

Illustrative Embodiment 20. The method of any one of illustrative embodiments 18-19, further comprising: incrementing the counter in response to the results of the determining whether the received capsule includes the at least one security tag indicates an absence of the at least one security tag from the received capsule; and resetting the counter in response to the results of the determining whether the received capsule includes the at least one security tag indicates a presence of the at least one security tag in the received capsule.

Illustrative Embodiment 21. The method of any one of illustrative embodiments 18-20, wherein the first desired threshold value corresponds to a maximum number of capsules included in a retail package of capsules, the retail package of capsules including a plurality of capsules.

Illustrative Embodiment 22. The method of any one of illustrative embodiments 18-21, wherein the first desired threshold value is set according to 2N−1, wherein N is a maximum number of capsules included in a retail package of capsules, the retail package of capsules including a plurality of capsules.

Illustrative Embodiment 23. The method of any one of illustrative embodiments 18-22, wherein the first desired threshold value is set based on a distribution ratio of capsules including the at least one security tag and a desired confidence level of detecting a capsule including the at least one security tag.

Illustrative Embodiment 24. The method of any one of illustrative embodiments 18-23, wherein a first capsule included in each retail package of capsules of a plurality of retail packages of capsules is guaranteed to contain the at least one security tag.

Illustrative Embodiment 25. The method of any one of illustrative embodiments 18-24, wherein a randomly selected capsule included in each retail package of capsules of a plurality of retail packages of capsules includes the at least one security tag.

Illustrative Embodiment 26. The method of any one of illustrative embodiments 18-25, wherein a plurality of security tags are randomly distributed among a plurality of capsules included in a plurality of retail packages of capsules; and no retail package of the plurality of retail packages is guaranteed to include a capsule including the security tag of the plurality of security tags.

Illustrative Embodiment 27. The method of any one of illustrative embodiments 18-26, further comprising: displaying a warning message to an adult consumer on a display panel of the aerosol generating device based on the determined statistical probability of authenticity of the capsule.

Illustrative Embodiment 28. The method of any one of illustrative embodiments 18-27, further comprising: transmitting a warning message to an electronic device associated with an adult consumer based on the determined statistical probability of authenticity of the capsule.

Illustrative Embodiment 29. The method of any one of illustrative embodiments 18-28, further comprising: disabling power to a heating element included in the aerosol generating device in response to the determined statistical probability of authenticity indicating the capsule is not authentic.

Illustrative Embodiment 30. The method of any one of illustrative embodiments 18-29, further comprising: disabling power to a heating element included in the aerosol generating device in response to the count of the counter exceeding a second desired threshold value.

Illustrative Embodiment 31. The method of illustrative embodiment 30, wherein the second desired threshold value is greater than the first desired threshold value.

Illustrative Embodiment 32. The method of any one of illustrative embodiments 30-31, wherein the second desired threshold value is equal to the first desired threshold value.

Illustrative Embodiment 33. A retail package comprising: a plurality of capsules each containing an aerosol-forming substrate, each capsule configured to be received by an aerosol generating device; and at least one capsule of the plurality of capsules included in the retail package including at least one security tag, the at least one security tag configured to be detected by the aerosol generating device and enable the aerosol generating device to determine a statistical probability of authenticity of the received capsule.

Illustrative Embodiment 34. The retail package of illustrative embodiment 33, wherein a first capsule included in the retail package is guaranteed to contain the at least one security tag.

Illustrative Embodiment 35. The retail package of any one of illustrative embodiments 33-34, wherein a randomly selected capsule of the plurality of capsules included in the retail package includes the at least one security tag.

Illustrative Embodiment 36. The retail package of any one of illustrative embodiments 33-35, wherein the at least one security tag is two or more security tags; and two or more capsules of the plurality of capsules included in the retail package include the two or more security tags.

We claim:

1. An aerosol generating device comprising:
a housing configured to receive a capsule, the capsule containing an aerosol-forming substrate;
a heating element configured to heat the aerosol-forming substrate to generate an aerosol; and
control circuitry configured to,
determine whether the received capsule includes at least one security tag using at least one security sensor,
increment a counter based on results of the determining whether the received capsule includes the at least one security tag, and
determine a statistical probability of authenticity of the received capsule based on a count of the counter and a first desired threshold value.

2. The aerosol generating device of claim 1, wherein
the received capsule is provided in a retail package of capsules;
the retail package of capsules includes a plurality of capsules including the received capsule; and
a single capsule of the plurality of capsules included in the retail package of capsules includes the at least one security tag.

3. The aerosol generating device of claim 1, wherein the control circuitry is further configured to:
increment the counter in response to the results of the determining whether the received capsule includes the at least one security tag indicating an absence of the at least one security tag from the received capsule; and
resetting the counter in response to the results of the determining whether the received capsule includes the at least one security tag indicating a presence of the at least one security tag in the received capsule.

4. The aerosol generating device of claim 1, wherein the first desired threshold value corresponds to a maximum number of capsules included in a retail package of capsules, the retail package of capsules including a plurality of capsules.

5. The aerosol generating device of claim 1, wherein the first desired threshold value is set according to 2N−1, wherein N is a maximum number of capsules included in a retail package of capsules, the retail package of capsules including a plurality of capsules.

6. The aerosol generating device of claim 1, wherein the first desired threshold value is set based on a distribution ratio of capsules including the at least one security tag and a desired confidence level of detecting a capsule including the at least one security tag.

7. The aerosol generating device of claim 1, wherein a first capsule included in a retail package of capsules is guaranteed to include the at least one security tag.

8. The aerosol generating device of claim 1, wherein a randomly selected capsule included in each retail package of capsules includes the at least one security tag.

9. The aerosol generating device of claim 1, wherein
a plurality of security tags are randomly distributed among a plurality of capsules included in a plurality of retail packages of capsules; and
no retail package of the plurality of retail packages is guaranteed to include a capsule including the at least one security tag of the plurality of security tags.

10. The aerosol generating device of claim 1, further comprising:
a display panel; and
wherein the control circuitry is further configured to:
display a warning message to an adult consumer on the display panel based on the determined statistical probability of authenticity of the capsule.

11. The aerosol generating device of claim 1, wherein the control circuitry is further configured to:
transmit a warning message to an electronic device associated with an adult consumer based on the determined statistical probability of authenticity of the received capsule.

12. The aerosol generating device of claim 1, wherein the control circuitry is further configured to:
disable power to the heating element in response to the determined statistical probability of authenticity indicating the capsule is not authentic.

13. The aerosol generating device of claim 1, wherein the control circuitry is further configured to:
disable power to the heating element in response to the count of the counter exceeding a second desired threshold value.

14. The aerosol generating device of claim 13, wherein the second desired threshold value is greater than the first desired threshold value.

15. The aerosol generating device of claim 13, wherein the second desired threshold value is equal to the first desired threshold value.

16. The aerosol generating device of claim 1, wherein
the aerosol generating device is a heat-not-burn aerosol generating device.

17. The aerosol generating device of claim 1, wherein
the aerosol generating device is an e-vapor aerosol generating device.

18. A method of operating an aerosol generating device, the method comprising:
determining whether a capsule received by the aerosol generating device includes at least one security tag using at least one security sensor, the capsule containing an aerosol-forming substrate;
incrementing a counter based on results of the determining whether the received capsule includes the at least one security tag; and
determining a statistical probability of authenticity of the received capsule based on a count of the counter and a first desired threshold value.

19. The method of claim 18, wherein
the received capsule is provided in a retail package of capsules;
the retail package of capsules includes a plurality of capsules including the received capsule; and
a single capsule of the plurality of capsules included in the retail package of capsules includes the at least one security tag.

20. The method of claim 18, further comprising:
incrementing the counter in response to the results of the determining whether the received capsule includes the at least one security tag indicates an absence of the at least one security tag from the received capsule; and
resetting the counter in response to the results of the determining whether the received capsule includes the at least one security tag indicates a presence of the at least one security tag in the received capsule.

21. The method of claim 18, wherein the first desired threshold value corresponds to a maximum number of capsules included in a retail package of capsules, the retail package of capsules including a plurality of capsules.

22. The method of claim 18, wherein the first desired threshold value is set according to 2N−1, wherein N is a maximum number of capsules included in a retail package of capsules, the retail package of capsules including a plurality of capsules.

23. The method of claim 18, wherein the first desired threshold value is set based on a distribution ratio of capsules including the at least one security tag and a desired confidence level of detecting a capsule including the at least one security tag.

24. The method of claim 18, wherein a first capsule included in each retail package of capsules of a plurality of retail packages of capsules is guaranteed to contain the at least one security tag.

25. The method of claim 18, wherein a randomly selected capsule included in each retail package of capsules of a plurality of retail packages of capsules includes the at least one security tag.

26. The method of claim 18, wherein
a plurality of security tags are randomly distributed among a plurality of capsules included in a plurality of retail packages of capsules; and
no retail package of the plurality of retail packages is guaranteed to include a capsule including the security tag of the plurality of security tags.

27. The method of claim 18, further comprising:
displaying a warning message to an adult consumer on a display panel of the aerosol generating device based on the determined statistical probability of authenticity of the capsule.

28. The method of claim 18, further comprising:
transmitting a warning message to an electronic device associated with an adult consumer based on the determined statistical probability of authenticity of the capsule.

29. The method of claim 18, further comprising:
disabling power to a heating element included in the aerosol generating device in response to the determined statistical probability of authenticity indicating the capsule is not authentic.

30. The method of claim 18, further comprising:
disabling power to a heating element included in the aerosol generating device in response to the count of the counter exceeding a second desired threshold value.

31. The method of claim 30, wherein the second desired threshold value is greater than the first desired threshold value.

32. The method of claim 30, wherein the second desired threshold value is equal to the first desired threshold value.

33. A retail package comprising:
a plurality of capsules each containing an aerosol-forming substrate, each capsule configured to be received by an aerosol generating device; and
at least one capsule of the plurality of capsules included in the retail package includes at least one security tag, the at least one security tag configured to be detected by the aerosol generating device and enable the aerosol generating device to determine a statistical probability of authenticity of the received capsule.

34. The retail package of claim 33, wherein a first capsule included in the retail package is guaranteed to contain the at least one security tag.

35. The retail package of claim 33, wherein a randomly selected capsule of the plurality of capsules included in the retail package includes the at least one security tag.

36. The retail package of claim 33, wherein
the at least one security tag is two or more security tags; and
two or more capsules of the plurality of capsules included in the retail package include the two or more security tags.
